(19) United States
(12) Patent Application Publication
(10) Pub. No.: US 2024/0217736 A1
(43) Pub. Date: Jul. 4, 2024

(54) SUBHOPPER ASSEMBLY FOR REFUSE VEHICLE

(71) Applicant: Oshkosh Corporation, Oshkosh, WI (US)

(72) Inventors: Vince Schad, Oshkosh, WI (US); Erik Ellifson, Oshkosh, WI (US); Eric Braun, Oshkosh, WI (US); Brady Slaughter, Oshkosh, WI (US); Patrick Dillman, Hartford, WI (US); Ryan Ullius, Oshkosh, WI (US); Jeremy Kiekhaefer, Oshkosh, WI (US); Martin J. Schimke, Red Granite, WI (US); Caleb Binder, Oshkosh, WI (US); Bennett Unfried, Oshkosh, WI (US); Derek Wente, Austin, MN (US); Jacob Wallin, Oshkosh, WI (US); Matt Erickson, Oshkosh, WI (US)

(21) Appl. No.: 18/399,531

(22) Filed: Dec. 28, 2023

Related U.S. Application Data
(60) Provisional application No. 63/435,968, filed on Dec. 29, 2022.

(51) Int. Cl. B65F 3/20; B65F 3/28

(52) U.S. Cl. CPC B65F 3/201; B65F 3/205; B65F 3/28

(57) ABSTRACT

Provided herein is a refuse vehicle includes a chassis, a cab coupled to the chassis, a body coupled to the chassis and housing a hopper, and a subhopper disposed adjacent or at least partially within the hopper. The subhopper includes a sloped upper surface configured to direct refuse deposited into the hopper toward an end of the hopper.

### CROSS-REFERENCE TO RELATED PATENT APPLICATIONS

The present application claims the benefit of and priority to U.S. Provisional Patent Application No. 63/435,968, filed Dec. 29, 2022, which is incorporated herein by reference in its entirety for any purpose whatsoever.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

Refuse vehicles may have a hopper for containing the refuse during collection and transport. Refuse may be a mixture of solid and liquid refuse. Liquids may leach from the refuse and mix within the hopper, occupying a portion of the hopper. This leachate may splash during transport of the refuse, coating the interior of the hopper and components of the refuse vehicle with the leachate. The refuse vehicles may be front loading, in which case the refuse is collected near the front end of the vehicle and then is deposited into the hopper, or side loading, in which case refuse is collected alongside of the hopper and/or refuse body and deposited into the hopper. During collection of the refuse, the refuse may accumulate near a location at which refused is deposited into the hopper, reducing the effective capacity of the hopper by causing other portions of the hopper to be underutilized.

### SUMMARY

One embodiment relates to a refuse vehicle. The refuse vehicle includes a chassis, a cab coupled to the chassis, a body coupled to the chassis and housing a hopper to contain refuse, an onboard power source (e.g., a battery pack or motor), and a subhopper. The subhopper may be fully or partially contained within the hopper of the refuse vehicle. Alternatively, the subhopper may be positioned outside of the hopper. The subhopper may be coupled to an actuator and may be movable between a first position and a second position. In some embodiments, the subhopper includes a packer member that is itself movable relative to the subhopper between a first position and a second position. The packer member of the subhopper may be coupled with an actuator. The packer member may move between the first position and the second position by linear motion or rotation.

Another embodiment relates to a subhopper for use in a refuse vehicle. The subhopper may include a body featuring a sloped upper surface. The subhopper may be coupled to an actuator and may be movable between at least a ready position and an eject position. In some embodiments, the subhopper is linearly movable between the ready position and the eject position. In some embodiments, the subhopper is rotatably movable between the ready position and the eject position. In some embodiments, the movement of the subhopper between the ready position and the eject position is a combination of linear movement, axial movement, and rotational movement.

In some embodiments, the subhopper includes a packer member that is itself movable relative to the subhopper between a ready position and a packing position. In some embodiments, when the packer member is in the ready position, a refuse volume is defined in the body of the subhopper. The packer member of the subhopper may be coupled with an actuator. The packer member may move between the ready position and the packing position by linear motion or rotation. In some embodiments, the subhopper includes multiple packer members. In some of these embodiments, the packer members may be individually movable between ready positions and packing positions.

In another aspect, provided herein is a refuse vehicle including: a chassis; a cab coupled to the chassis; a body coupled to the chassis and defining a hopper; and a subhopper disposed least partially within the hopper, wherein the subhopper comprises a main body having a sloped upper surface configured to direct refuse deposited into the hopper toward an end of the hopper.

In some embodiments, the subhopper also includes a packing assembly featuring a packer member coupled to an actuator, wherein the packer member is movable relative to the main body between a first position and a second position. In some embodiments, the packer member is movable between the first position and the second position by rotation of the packer member. In some embodiments, the refuse vehicle also features an electric actuation system coupled to the subhopper, where the electric actuation system is configured to reposition the subhopper relative to the body within at least a portion of the hopper between a receiving position and an eject position. In some embodiments, the subhopper includes at least one packing member movable with respect to the subhopper. In some embodiments, the packing member is movable from a first ready position to a second packing position, and the subhopper and packing member are together movable to a third eject position.

In some embodiments, the subhopper also includes a packing assembly featuring a plurality of packer members. The plurality of packer members are independently actuatable or movable relative to the main body from ready positions to packing positions. In some embodiments, the plurality of packer members are positioned in a vertical arrangement such that a first packer member is positioned below a second packer member. In some embodiments, the plurality of packer members are positioned in a horizontal arrangement such that a first packer member is positioned alongside a second packer member.

In another aspect, a subhopper for use in a refuse vehicle is provided herein. In some embodiments, the subhopper includes: a main body defining an interior cavity of the subhopper; a packer member disposed within the interior cavity and movable relative to the main body between a receiving position and a packing position; and an actuator coupled to the packer member and the main body and configured to selectively reposition (i) the packer member with respect to the main body, and (ii) both the main body and the packer member at the same time.

In some embodiments, the subhopper includes a subhopper actuator coupled to the subhopper, wherein the subhopper is movable within a hopper between a first ready position and an eject position. In some embodiments, the main body includes a sloped upper surface configured to direct refuse deposited into the subhopper toward an end of the interior cavity of the subhopper. In some embodiments, the subhopper also includes a second packer member positioned alongside the packer member in a horizontal relation, the second packer member actuatable between a first ready position and a second packing position. In some embodiments, the subhopper also includes a second packer member positioned above the packer member in a vertical relation. In some embodiments, the packer member is movable between a ready first position and a second packing position by rotation of the packer member.

In another aspect, a subhopper assembly is provided, the assembly including: a subhopper configured to be positioned within a hopper volume of a refuse container; and a packer member positioned at least partially above the subhopper, wherein the packing member has a sloped upper surface and is moveable from a first ready position to a second packing position independent of the subhopper.

In some embodiments, the subhopper assembly includes a subhopper actuator coupled to the subhopper, wherein the subhopper is configured to be movable within a hopper between a first ready position and an eject position. In some embodiments, the subhopper assembly includes a second packer member actuatable between a first ready position and a second packing position. In some embodiments, the second packer member is positioned between the packer member and the subhopper in a vertical relation. In some embodiments, the packer member is movable between a ready first position and a second packing position by rotation of the packer member.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a refuse vehicle, according to an exemplary embodiment.

FIG. 2 is a side view of a vehicle body of a refuse vehicle that may be used with the refuse vehicle of FIG. 1.

FIG. 3 is a side view of another vehicle body of a refuse vehicle that may be used with refuse vehicle of FIG. 1.

FIG. 4 is a side view of yet another vehicle body of a refuse vehicle that may be used with the refuse vehicle of FIG. 1, with a rear lift gate of the body assembly in an open position.

FIG. 5 is a perspective view of a vehicle body of a refuse vehicle that includes a subhopper assembly, accordingly to an exemplary embodiment.

FIG. 6 is a top view of the subhopper assembly of FIG. 5, showing a packer member in a ready position.

FIG. 7 is another top view of the subhopper assembly of FIG. 5, showing the packer member in a packing position.

FIG. 8 is yet another top view of the subhopper assembly of FIG. 5, showing the subhopper assembly in an eject position.

FIG. 9 is a side view of another vehicle body of a refuse vehicle that includes a subhopper assembly, showing the subhopper assembly with a packer in a ready position.

FIG. 10 is a side view of the subhopper assembly of FIG. 9 showing the packer in a ready position and showing refuse entering the hopper.

FIG. 11 is a side view of the subhopper assembly of FIG. 9 showing the packer in a packing position.

FIG. 12 is a side view of the subhopper assembly of FIG. 9 showing the subhopper assembly in an eject position.

FIG. 13 is a perspective view of yet another vehicle body of a refuse vehicle that includes a subhopper assembly, according to an exemplary embodiment.

FIG. 14 is a perspective view of yet another vehicle body of a refuse vehicle that includes a subhopper assembly, according to an exemplary embodiment.

FIG. 15 is a perspective view of a subhopper assembly for a refuse vehicle that includes a packer member having a linear rack and pinion actuator assembly, according to an exemplary embodiment.

FIG. 16 is a perspective view of a subhopper assembly that includes a telescopic chain actuator system, according to an exemplary embodiment.

FIG. 17 is a side view of the telescopic chain actuator system of FIG. 16 in a retracted position.

FIG. 18 is a section view of the telescopic chain actuator system of FIG. 16.

FIG. 19 is a schematic of a telescopic chain actuator system, according to an exemplary embodiment.

FIGS. 20A and 20B are schematic illustrations of a telescopic chain actuator system, according to an exemplary embodiment.

FIG. 21 is a perspective view of a subhopper assembly that includes a cascade drive actuator assembly, according to an exemplary embodiment.

FIG. 22 is a perspective view of linear actuators for a subhopper assembly of a refuse vehicle, according to an exemplary embodiment.

FIG. 23 is a perspective view of another linear actuator for a subhopper assembly of a refuse vehicle, according to an exemplary embodiment.

FIG. 24 is a rear perspective view of a packer member, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

At least one embodiment of the present disclosure relates to a subhopper assembly for a refuse vehicle that is configured to improve utilization of space within a vehicle body of the refuse vehicle during loading operations. The subhopper assembly may be disposed within the vehicle body, in a hopper portion of the vehicle body that is positioned to receive waste from an external source. The subhopper assembly may be alignable with an access door (e.g., top door, etc.) of the vehicle body, so as to receive waste and other material during loading operations. The subhopper assembly may include a main body (e.g., a receiving body, etc.) having angled walls that are configured to receive refuse from a loader assembly of the refuse vehicle and to direct the refuse into an interior compartment of the vehicle body to improve distribution of the waste and/or other material within the interior compartment.

In various embodiments, the suphopper assembly may also include a packer assembly including a packer member that is configured to move relative to main body during operations to push refuse away from the main body and/or to compact refuse within the interior compartment, thereby preventing build-up of refuse and/or other material within the main body. Both the main body and the packer assembly may be movable within the vehicle body, and may be configured to move relative within the vehicle body to facilitate ejection of stored refuse within the internal compartment (e.g., toward a rear end of the vehicle body away from the subhopper assembly, etc.). Among other benefits, the subhopper assembly improves distribution of waste and/or other material within the interior compartment during loading operations and reduces the effects of material spring-back during packing operations, thereby resulting in greater use of the interior compartment and increasing the effective collection capacity of the refuse vehicle.

As used herein, the term “hopper” refers to a container or a fillable portion of a container, such as an interior compartment of a refuse vehicle body, that is positioned to receive waste and/or other material from an external source, such as a municipal and/or commercial waste receptacle. While the hopper may be discussed in reference to a refuse vehicle, it should be understood that the principles discussed herein could also be applied to other refuse receptacle designs that are not attached to a refuse vehicle. As used herein, the term “subhopper” refers to a device, structure, or assembly that functions to improve the distribution of material deposited into the hopper. It is contemplated that the subhopper may be positioned within the hopper or partially within the hopper. It is also contemplated that the subhopper may be positioned outside of the hopper.

Refuse Compartment with Subhopper

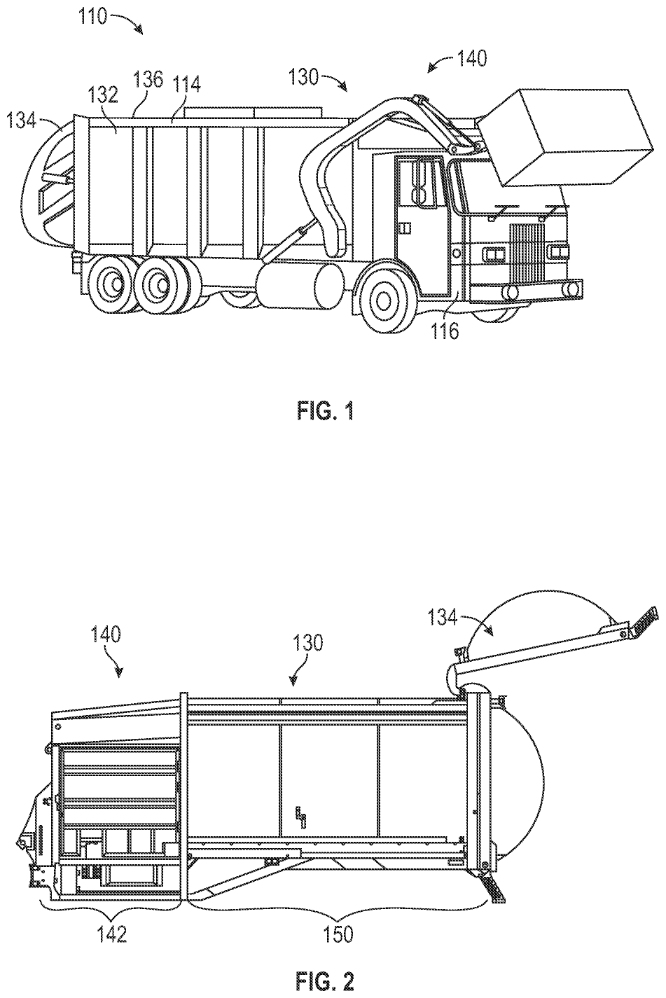

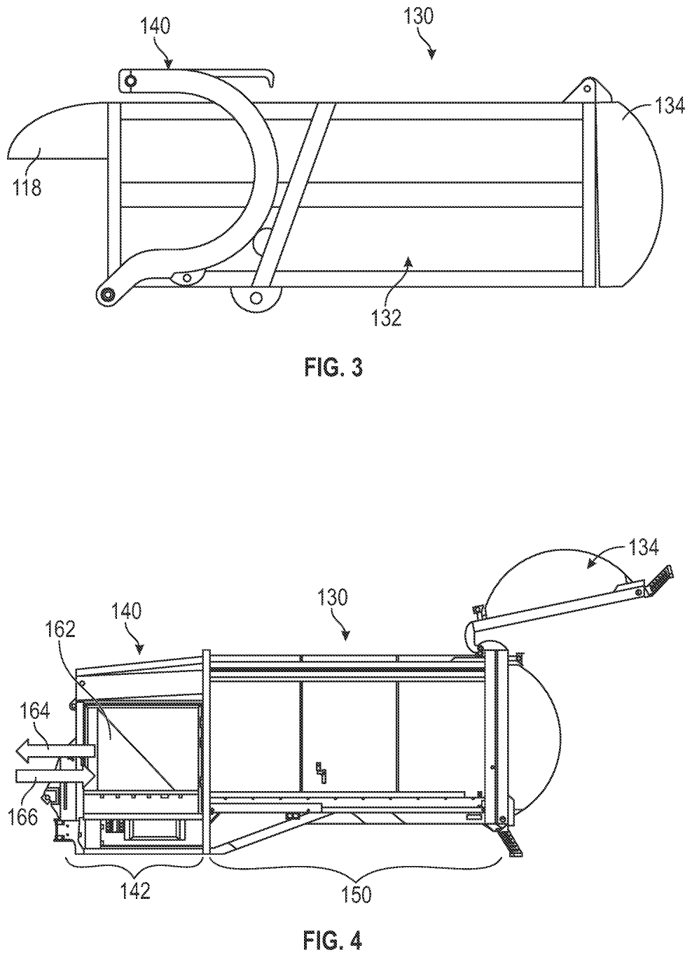

Referring to FIG. 1, a refuse vehicle is shown as vehicle 110. The refuse vehicle 110 is configured to transport refuse from various waste receptacles to a storage and/or processing facility (e.g., a landfill, an incineration facility, a recycling facility, etc.). The refuse vehicle 110 includes a chassis (e.g., a frame, etc.), and a vehicle body (e.g., body assembly, etc.), shown as body 114 coupled to the chassis. The body 114 may be a refuse storage vessel that is configured to receive and store refuse, such as garbage from residential and/or commercial refuse containers. As shown in FIGS. 1-4, the body 114 may include a plurality of panels, shown as panels 132, a tailgate 134, and a cover 136. The panels 132, the tailgate 134, and the cover 136 define a collection chamber (e.g., interior compartment, refuse compartment, waste receptacle, etc.), shown as refuse compartment 130. Loose refuse and/or other material may be placed into the refuse compartment 130 where it may thereafter be compacted (e.g., by a packer system, etc.). The refuse compartment 130 may provide temporary storage for refuse during transport to a waste disposal site and/or a recycling facility. In some embodiments, at least a portion of the body 114 and the refuse compartment 130 extend above or in front of the cab 116. According to the embodiment shown in FIG. 1, the body 114 and the refuse compartment 130 are positioned behind the cab 116.

In some embodiments, as in the embodiment in FIG. 2, the refuse compartment 130 includes a hopper volume 142 and a storage volume 150. The hopper volume 142 may house a hopper 140. Refuse may be deposited into the hopper 140 and distributed from the hopper 140 into the storage volume 150. Refuse may be initially loaded into the hopper 140 and transported into the hopper volume, and thereafter compacted into the storage volume 150. According to an exemplary embodiment, the hopper volume 142 is positioned between the storage volume and the cab 116 (e.g., refuse is loaded into a position of the refuse compartment 130 behind the cab 116 and stored in a position further toward the rear of the refuse compartment 130, a front-loading refuse vehicle, a side-loading refuse vehicle, etc.). In other embodiments, the storage volume may be positioned between the hopper volume and the cab 116 (e.g., a rear-loading refuse vehicle, etc.).

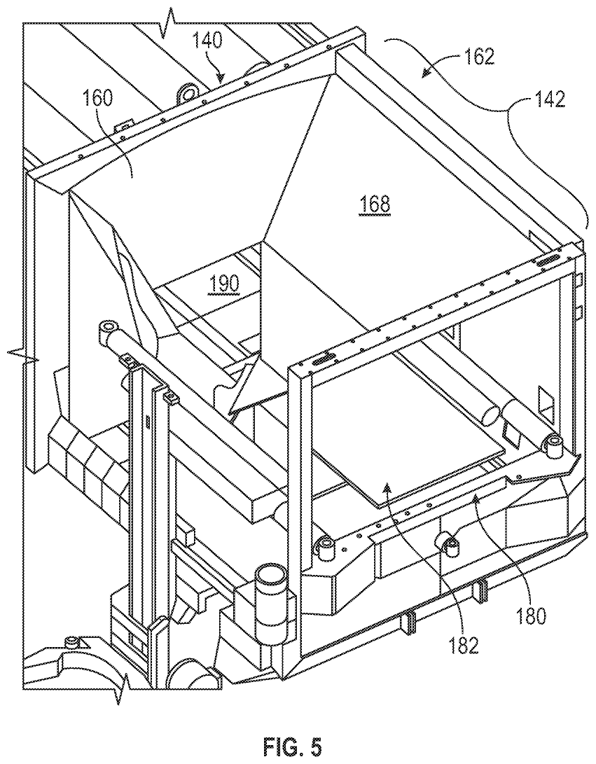

With reference to FIGS. 4 and 5, according to an exemplary embodiment, a refuse vehicle hopper 140 includes a subhopper assembly 160, shown as subhopper 162. The subhopper 162 may be positioned partially or wholly within the hopper 140 or hopper volume 142. Alternatively, or depending upon an operating condition of the refuse vehicle, the subhopper 162 may be positioned outside of the hopper 140 or the hopper volume 142 (e.g. toward a rear end of the vehicle body during eject operations, as will be further described). The subhopper 162 may include at least one sloped upper surface 168 that may function to direct refuse material deposited into the hopper 140 into a receiving volume of the subhopper 162 and/or to direct refuse material deposited into the subhopper 162 away from the hopper volume 142 and into the storage volume 150. In one exemplary, the subhopper 162 is positioned near the front end of the refuse compartment 130 and is configured to direct the material deposited into the subhopper 162 toward the rear end of the refuse compartment 130. The subhopper 162 made be made of one or more materials including high durability plastic or metal.

With continued reference to FIG. 4, the subhopper 162 may include actuators to move the subhopper 162 and/or portions thereof relative to the vehicle body (e.g., into the storage volume 150). In some exemplary embodiments, the subhopper 162 may be movable in a first direction 164 (e.g., a longitudinal direction parallel to the vehicle chassis) toward the storage volume 150 of the refuse compartment 130. In some exemplary embodiments, the subhopper 162 may be movable in a second direction 166 away from the storage volume 150 of the refuse compartment 130. In some embodiments, the subhopper 162 is movable at least partially into the storage volume 150 of the refuse compartment 130. In some embodiments, the subhopper 162 is movable fully into the storage volume 150 of the refuse compartment 130.

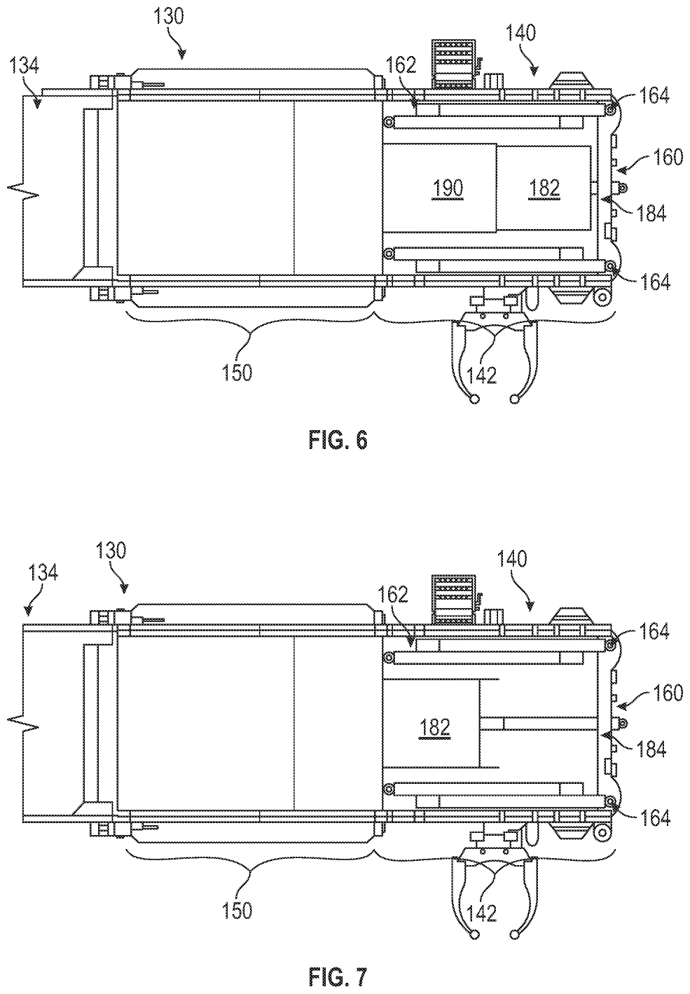

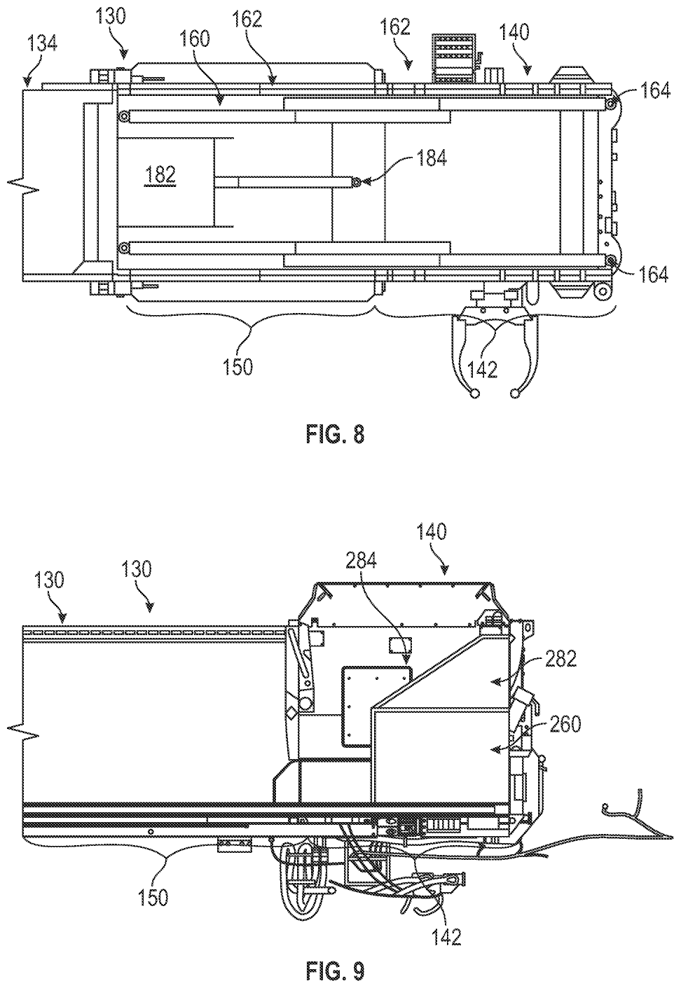

Referring to FIGS. 6-8, in some embodiments, the subhopper 162 is movable along a longitudinal direction (e.g., linearly, etc.) between the first position and the second position. In some embodiments, the subhopper 162 is rotatably movable between a first position and a second position. In some embodiments, the movement of the subhopper 162 may be movable between a first position and a second position by rotational movement and further movable to a third position by linear movement. In some embodiments, the movement of the subhopper 162 may be movable between a first position and a second position by linear movement and further movable to a third position by rotational movement. In an exemplary embodiment, the first position is a ready position (as in FIG. 6) in which the subhopper 162 is positioned to receive refuse, and the second position is an eject position (as in FIG. 8) used to eject refuse and/or other material contained within the storage volume 150 out of the refuse compartment 130.

With continued reference to FIGS. 6-8, in an exemplary embodiment, the subhopper 162 is movable by at least one subhopper actuator 164. The subhopper actuators 164 may extend or rotate to move the subhopper 162 from the first position to the second position, or to move portions of the subhopper toward the storage volume 150. The subhopper actuator 164 may be one or more types of various actuators configured to facilitate linear and/or rotational movement of the subhopper or portions thereof, as will be further described.

Returning to reference to FIGS. 5-8, in some embodiments, the subhopper may include a packing assembly 180 that is configured to push or otherwise move refuse and/or other material from an interior cavity portion of the subhopper assembly into the storage volume 150. The packing assembly 180 may include a packer member 182. The packer member 182 may be made of the same material as the subhopper 162 or made be made of a different material. The packer member may be disposed within the interior cavity portion of the subhopper and may be movable relative to the subhopper by a packing actuator 184 from a first position to a second position. In one exemplary embodiment, as in FIGS. 5-6, the first position of the packer member 182 may be a ready position. Also in this exemplary embodiment, as in FIGS. 5-8, the second position of the packer member 182 may be a packing position. In this exemplary embodiment, when the packer member 182 of the subhopper 162 is in the ready position, it defines a refuse volume 190 within the subhopper 162. Refuse deposited in the refuse compartment 130 through the hopper 140 may be directed by the sloped upper surface 168 of the subhopper 162 into the refuse volume 190 of the subhopper 162. The refuse within the refuse volume 190 of the subhopper 162 may be pushed into the storage volume 150 of the refuse compartment 130 by actuation of the packer member 182 into and through the refuse volume 190. As the packer member 182 moves relative to the subhopper 162, it may move the refuse contained within the refuse volume 190 into the storage volume 150, and/or may compact refuse and/or other material contained within the storage volume 150 to thereby increase the material holding capacity of the refuse vehicle. In this exemplary embodiment, the movement of the packer member 182 between the ready position and the packing position displaces a volume that is smaller than the volume displaced by the movement of the subhopper 162 between its ready position and the eject position. In this way, the refuse within the hopper may be directed and packed into the storage volume 150 of the refuse compartment 130 with less energy expenditure.

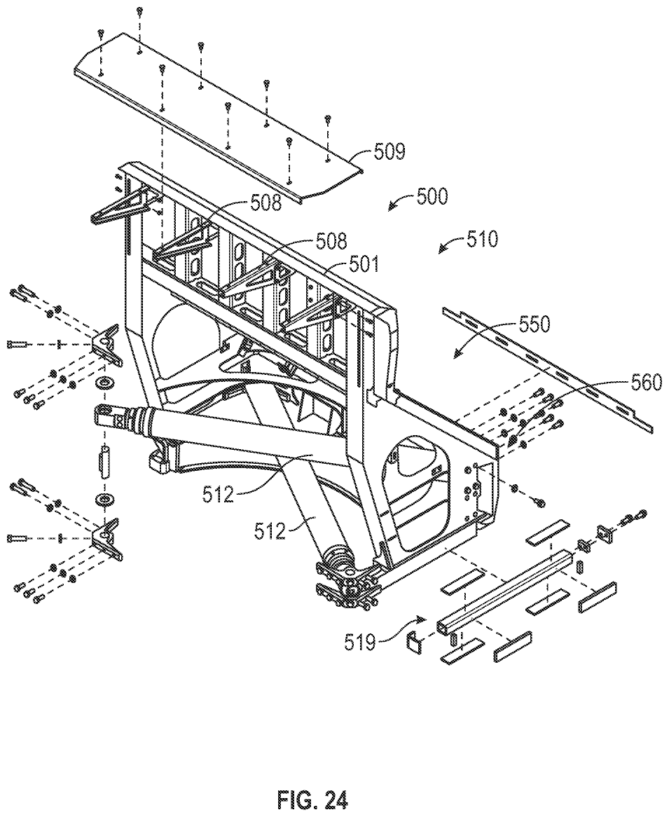

Turning to FIG. 24, an exemplary embodiment of a packing member 500 is shown. The exemplary packing member includes a packing surface 510 configured to engage the refuse and/or other material during material loading and compacting operations. The packing surface includes a first vertical portion 501, a sloped second portion 550, and third vertical portion 560 that are configured to efficiently engage with the refuse as it is packed. Additionally, the exemplary packing member 500 includes at least one support member 512 to prevent torque on the packing member 500 due to uneven distribution of refuse to cause rotation of the packing member 500. The packing member may also include lateral reinforcement members 519 that are configured to distribute loads uniformly across the vehicle body. The packing member may also include a cover 506 to prevent refuse from climbing the walls of the packing member during operation and to prevent refuse and/or other material from falling into an area behind the packing member. The cover 506 may include brace arms 508 coupled with the packing member 500 to secure the cover 506 in place. In this way, fouling or ingression of material into the mechanisms and other components located behind the packing member 500, such as the actuators and accompanying motors and electronic controllers, may be avoided. The packing member 500 may made be made of one or more materials including high durability plastic and/or metal.

### Subhopper Including Vertically Arranged Main Body and Packer Member

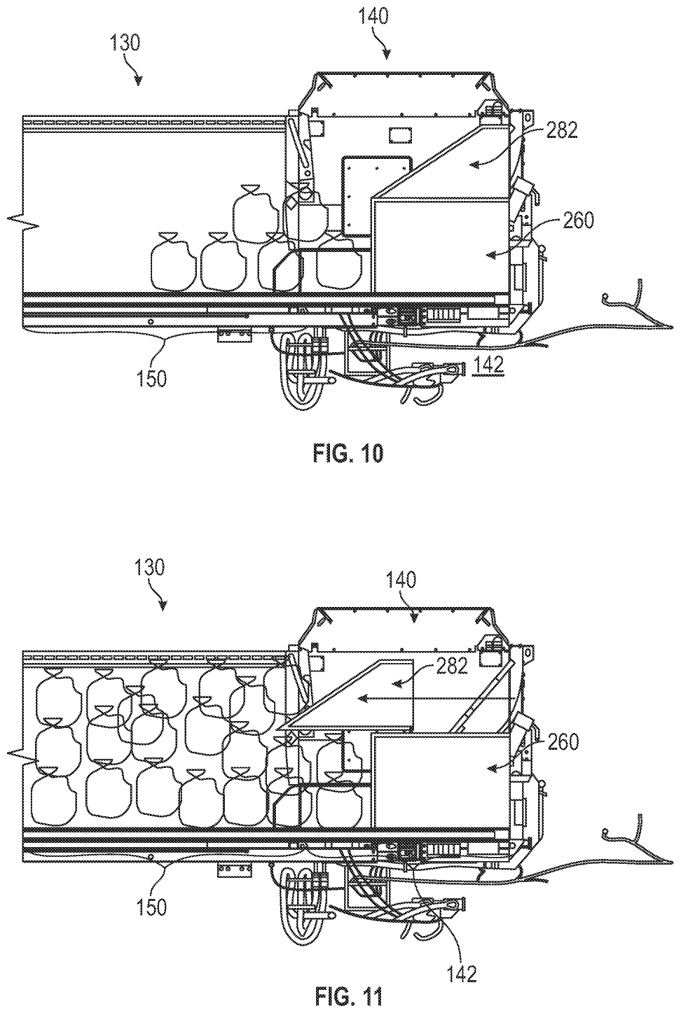

Turning to FIGS. 9-12, in another exemplary embodiment, a refuse compartment 130 may have a subhopper 260 including a main subhopper body and a packer member 282 in a vertical relation with the main subhopper body. Specifically, the packer member 282 may be positioned at least partially above the subhopper 260 and may include a sloped upper surface 284 that is exposed to refused as it is deposited into the refuse compartment 130. The sloped upper surface 284 of the packer member 282 that may function to direct refuse material deposited into the hopper into a more uniform distribution within the hopper 140 or to direct refuse material deposited into the hopper 140 away from the hopper volume 142 and into the storage volume 150. The upper sloped surface 284 of the packer member 282 in this way may eliminate the need to perform a packing function until the refuse container is substantially filled. This may save significant amounts of power, as the redistribution of refuse in the refuse compartment 130 may occur as a result of the impact of the refuse on the sloped surface and not due to a power-expending movement or actuation of equipment.

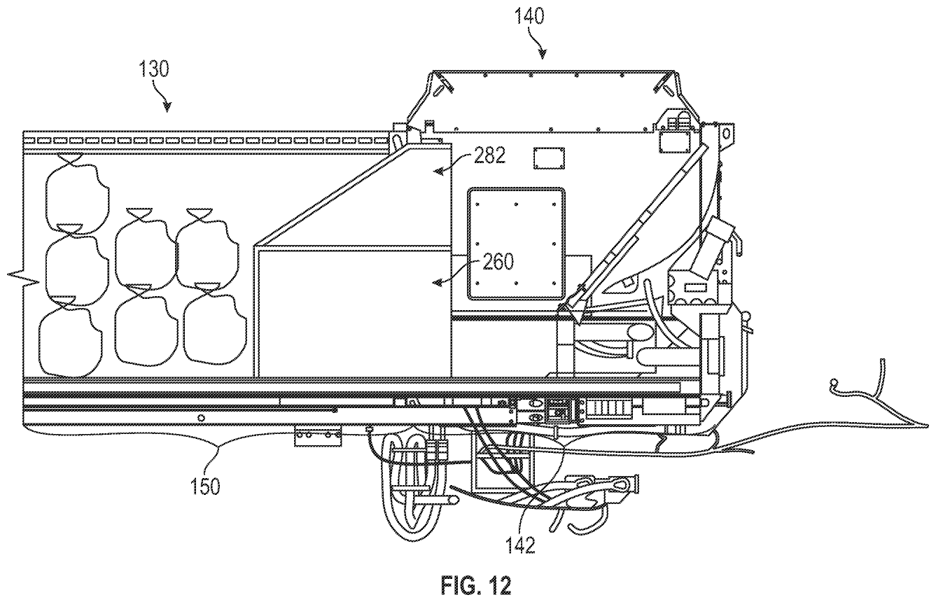

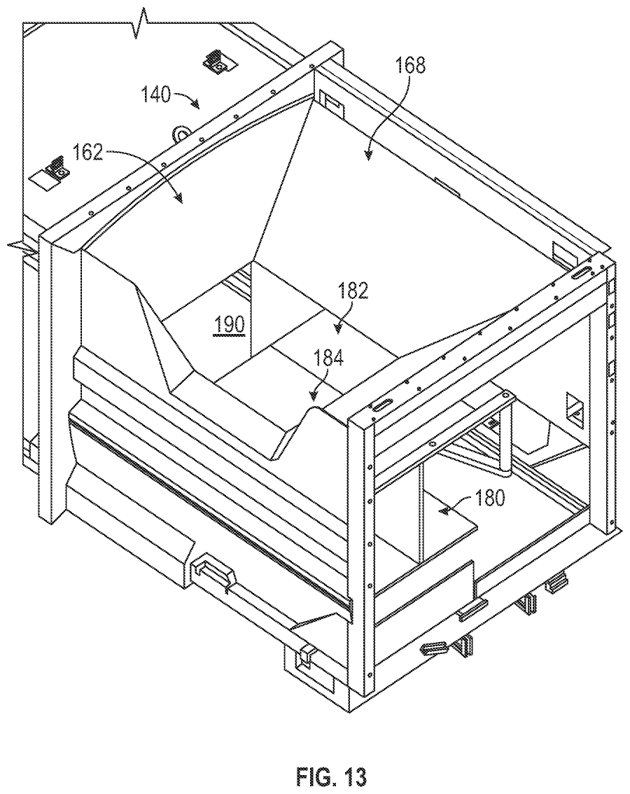

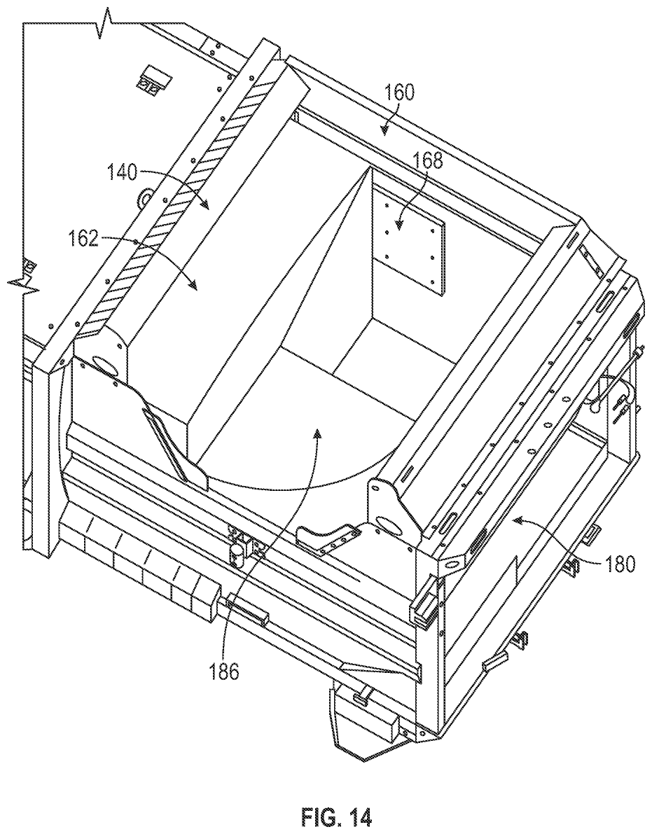

With continued reference to FIGS. 9-12, in the exemplary embodiment, the packer member 282 and the subhopper 260 may be independently movable. The packer member 282 may be movable between a first position (as in FIG. 9) and a second position (as in FIG. 11). In some embodiments, the packer member 282 is further movable into a third position (as in FIG. 12). In the exemplary embodiment, the first position of the packer member 282 is a ready position, wherein the packer member 282 is substantially contained within the hopper volume 142 of the refuse compartment 130 and does not interfere with the movement of refuse from the hopper 140 into the storage volume 150 of the refuse compartment 130. The second position of the packer member 282 may be a packing position (as in FIG. 11) wherein the packer member 282 may be extended into the storage volume 150 of the refuse compartment 130 to move refuse that has accumulated in the hopper volume 142 or in the volume of the storage volume 150 of the refuse compartment 130 into the rear portion of the storage volume 150. In some embodiments, the third position of the packer member 282 may be an eject position, wherein the packer member 282 extends into the storage volume 150 of refuse compartment 130 to assist with ejecting the refuse from the refuse compartment 130. It is contemplated that the packer member 282 may selectively move into the eject position either in tandem with or independently of the subhopper 260.

With continued reference to FIGS. 9-12, the subhopper 260 may be movable between a first position (as in FIG. 9) and a second position (FIG. 12). Movement of the subhopper 260 may be independent of the packer member 282 or it may be in tandem with the packer member 282. The subhopper 260 may movable from a first ready position (as in FIG. 9) wherein the subhopper is substantially contained within the hopper volume 142 of the refuse compartment 130. The subhopper 260 may be movable to a second eject position (as in FIG. 12), wherein at least a portion of the subhopper 260 moves into the storage volume 150 of the refuse compartment 130 to eject the refuse contained therein. Movement of the subhopper 260 may be accomplished through the use of at least one actuator. While the present disclosure contemplates the use of any suitable actuator known in the art, examples of actuators and configurations of the actuators is provided herein.

### Multiple Packer Members

Turning to FIG. 13, the packer member 182 of the subhopper assembly 160 of any of the above-described embodiments may include a packing assembly 180 that includes a plurality of packer members 182, 184. Foe ease of understanding, this disclosure describes the packing assembly with a plurality of packer members with reference to FIG. 13. However, it should be noted that a packing assembly with the packer member having a sloped upper surface and positioned above the subhopper may also include a plurality of packer members.

In an exemplary embodiment, the packing assembly 180 may include two packer members 182, 184. The packing assembly 180 may include three, four, or more packer members. The use of multiple packer members may reduce the power requirements and expenditure of the vehicle by permitting an operator to actuate only the packer members that need to move in order to redistribute the refuse within the refuse compartment 130.

Continuing with FIG. 13, the packer members may be independently actuatable or movable, or may be actuatable or movable in tandem with others of the packer members. In an exemplary embodiment, as in FIG. 13, the packing assembly 180 includes two packer members 182, 184. The first packer member 182 may be movable between a first position and a second position. The second packer member 184 may be movable between a first position and a second position. The first packer member 182 may be selectably independently movable or movable in tandem with the second packer member 184. The first packer member 182 may be coupled to a first actuator and the second packer member 184 may be coupled to a second actuator. The first packer member and the second packer member may be movable between a first position and a second position, and between a second position and a third position. In some embodiments, the first packer member 182 and the second packer member 184 may be movable between the first and third position. In the exemplary embodiment, the first position for the packer member 182, 184 is a ready position. When in the ready position, the packer members 182, 184 and the subhopper 162 define a refuse volume 190 in the subhopper 162 where refuse may accumulate as it is deposited into the refuse compartment 130. The first packer member 182 and second packer member 184 may move either independently or in tandem into the refuse volume 190 into a second packing position, thereby moving at least a portion of the refuse within the refuse volume 190 into the storage volume 150 of the refuse compartment 130. In the exemplary embodiment, the first packer member 182 and second packer member 184 may be movable either independently or in tandem to a third eject position, in which the first packer member 182 and second packer member 184 assist in ejecting refuse from the storage volume 150 of the refuse compartment 130.

Continuing with FIG. 13, in the exemplary embodiment including independently movable first packer member 182 and second packer member 184, the operator of the refuse vehicle may choose to alternate between having the first packer member 182 in the ready or packing position and the second packer member 184 in the other of the ready or packing position. In this way, the effective volume of the refuse volume 190 of the subhopper 162 is reduced. This reduction in effective volume may result in less power usage by the refuse vehicle, as less force will be required by the actuator to move the refuse from the open portion of the refuse volume 190 into the storage volume 150 of the refuse compartment 130.

An alternative embodiment is shown in FIG. 14, wherein the packer member 186 moves rotationally within the subhopper 162. In this embodiment, the packer member 186 may rotationally or rotatably move between a first position and a second position. In some embodiments, the first position for the packer member 186 is a ready position, in which the packer member 182 and the subhopper 162 define a refuse volume within the subhopper 162. In some embodiments, the second position of the packer member 182 is a packing position. The packer member 182 may rotate from the ready position to the packing position, thereby moving any refuse within the refuse volume of the subhopper 162 out of the hopper volume 140 and into the storage volume 150 of the refuse compartment 130. While shown as a solid block in FIG. 14, the packer member 186 may also be a plate, hollow object, or other suitably shaped device.

### Actuation of Subhopper and Packer Members

The subhopper device and packer members of the above-described embodiments may be movable between a plurality of positions and may be actuated. The actuators to be used will generally depend on the motion needed, and any actuator or motor known in the art may be adopted to the needs of the devices. Specific possible methods and devices for actuating the subhopper and/or packer members as described above is provided herein.

As an initial matter, as referred to herein any “actuator” may refer to any component that is capable of performing the desired function. For any actuators coupled to or associated with the subhopper 162, the desired function may refer to move the subhopper 162 relative to the hopper volume 160 and the storage volume 130 of the refuse compartment 130. As previously disclosed, the movement may be linear, rotational, or a combination of linear and rotation motions. And for any actuators coupled to or associated with a packer member, the desired function may refer to the movement of the packer member relative to the subhopper or relative to the hopper volume and the storage volume. For example, the term “actuator” as used herein may refer to electric actuators configured to be powered via electricity provided by an energy storage and/or generation system onboard the chassis, ball screw actuators (e.g., ball screws driven by an electric motor), linear actuators, hydraulic cylinders driven by an electronically driven hydraulic pump (e.g., driven by the electric motor, the secondary electric motor, etc.), a rack and a pinion driven by an electric motor, a winch system that is configured to cause rotation, a torsion spring that causes actuation, or various other actuators. In another example, the actuators are an electric pump that pressurize a hydraulic fluid and then drive, lift, or rotate the various components through hydraulic cylinders filled with the pressurized hydraulic fluid. In yet another example, the actuators are electric high force ball screw actuators that provide enough force to drive, lift, or rotate the various components.

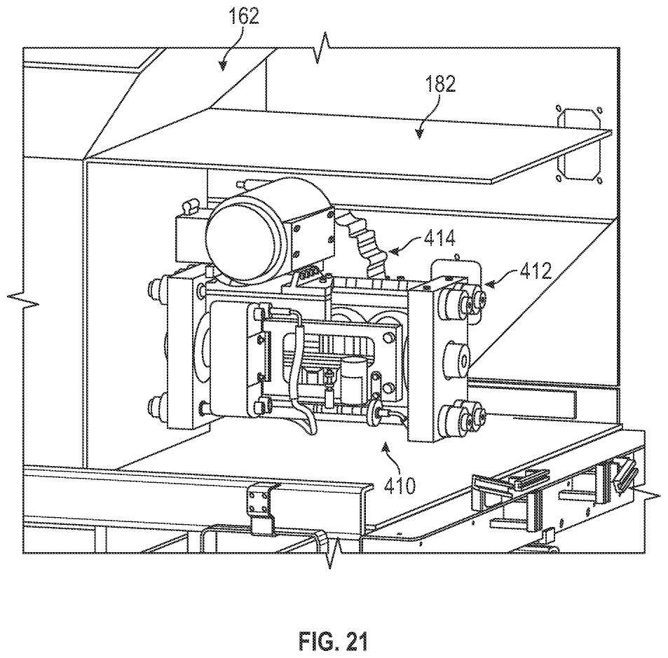

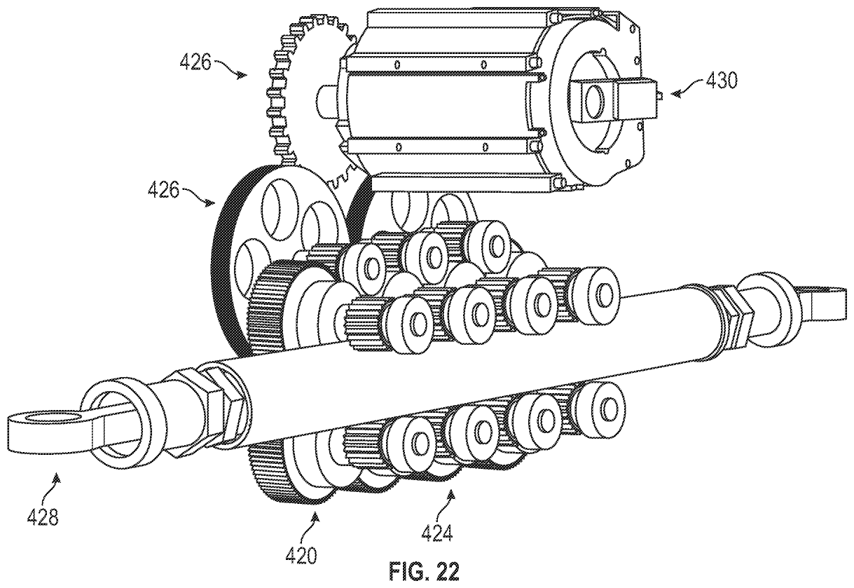

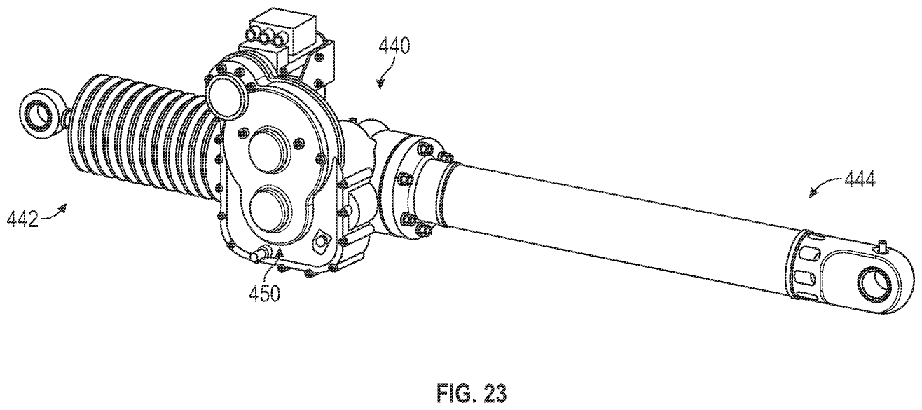

Turning to FIGS. 21-23, a packer member 182 may be coupled to an actuator 410. In the an exemplary embodiment of FIG. 21, the packer member 182 may be coupled to a hydraulic actuator. The hydraulic actuator may include an electrically driven hydraulic pump that pressurizes hydraulic fluid to apply force to a hydraulic shaft. With specific attention to FIGS. 22-23, in another exemplary embodiment, the actuator 410 is an electromechanical linear actuator. The actuator may include a motor 430, which may be electrically driven. In some embodiments, the motor may function to provide torque to a gear assembly 426 which in turn provides linear motion to a rack 422 having a mounting end 428. The mounting end 428 of the actuator may be coupled mechanically to at least a portion of the packer member 182. The actuator 410 may be single-ended or dual-ended. The motor and gear assembly may be housed in a motor housing 414 and a gear box housing 412 to protect the components from fouling or interference by refuse or leached liquids.

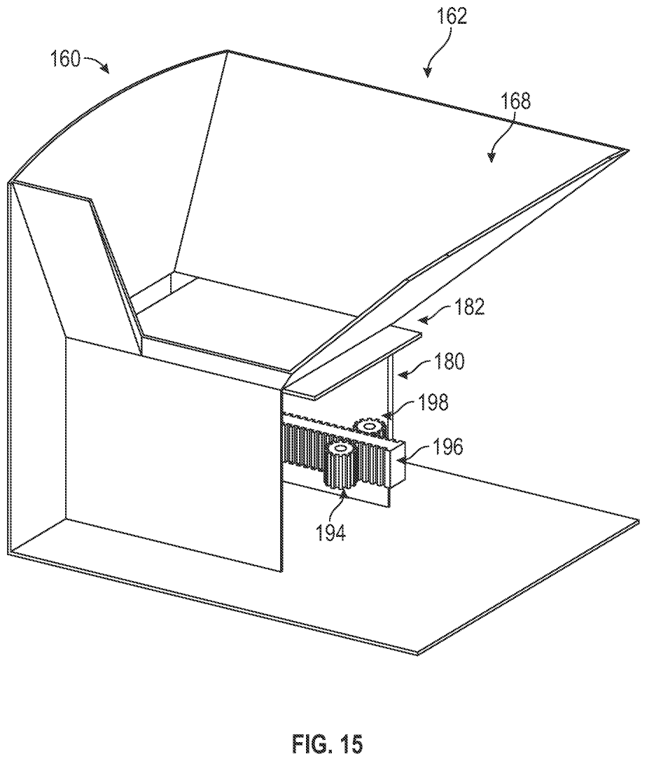

In another exemplary embodiment, as in FIG. 15, a motor (not shown) may connect or otherwise be coupled to a mechanism to drive the packer member 182. In the exemplary embodiment, the packer member 182 is coupled to a rack 196 and pinion 194, 198 assembly. A motor may be coupled to one or more pinions 194, 198 and provide rotational force. The pinions 194, 198 rotate and engage the rack 196. In so doing, the rack 196 and pinion 194, 198 assembly translates the rotational power provided by the motor into linear or translational movement of the rack 196. The rack 196 may be coupled to the packer member 182 such that movement of the rack provides movement of the packer member 182 as well.

### Chain Drives

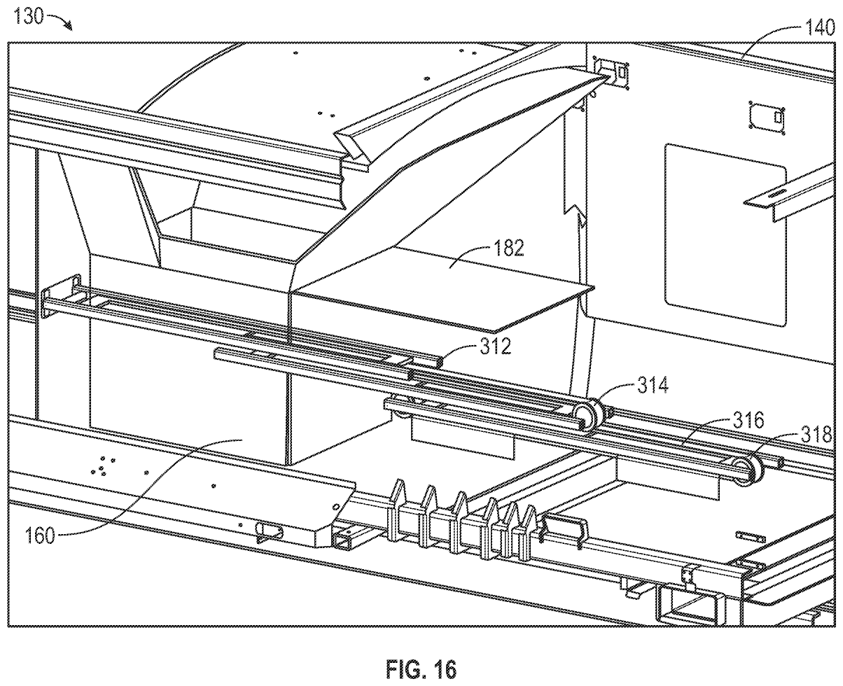

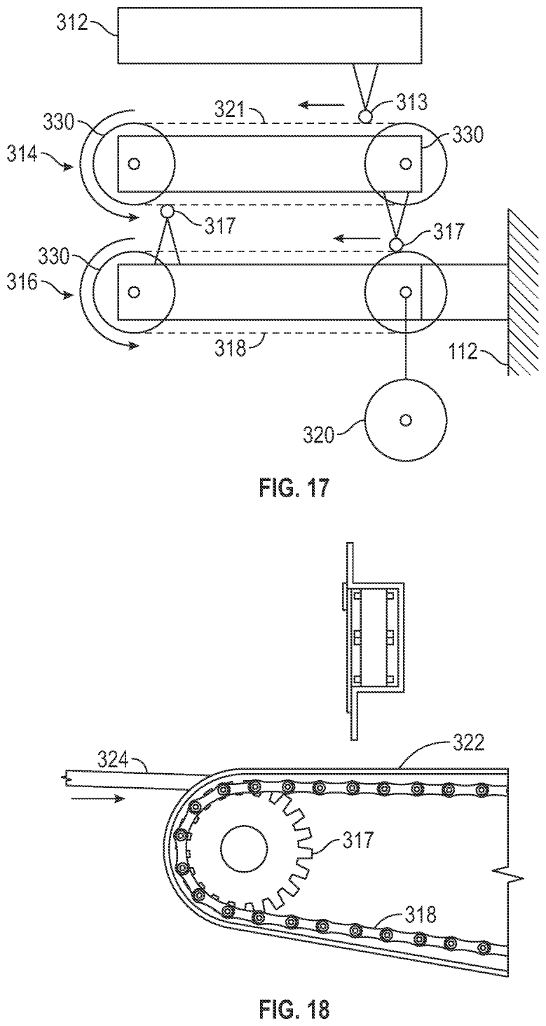

Turning now to FIGS. 16-20, an exemplary embodiment includes a telescopic chain drive 310 for moving the subhopper 182 from a first ready position within the hopper volume 140 into the storage volume 150 of the refuse compartment 130. In the exemplary embodiment, the chain drive 310 includes a first sliding rail 312 and a second sliding rail 314 coupled to a third fixed rail 316 that is attached to or other fixed to the refuse compartment 130. For example the third fixed rail 316 may be attached to a wall 112 of the refuse compartment 130 via an anchor. The second and third rails 314, 316 have rotatable gears or sprockets 330 that guide the chains 318, 321 around the rails. A first sprocket 330 on the fixed rail 316 is attached to a motor 320, which provides rotational power to the first sprocket, which in turn drives the chains. Anchors 315, 317, 313 are coupled to the chains 318, 321 at selected locations such that, as the chains move around the respective rails 314, 316, the rails telescopically extend. As the first rail 312 is coupled to the subhopper 162, the power of the telescoping rails is translated to the subhopper, moving it toward the rear of storage volume 150 of the refuse compartment 130 as the sliding rails 312, 314 extend away from the fixed rail 316. The sliding rails 312, 314 may be retracted by reversing the direction of the rotation provided to the first sprocket 330 by the motor, thereby also retracting the coupled subhopper 162.

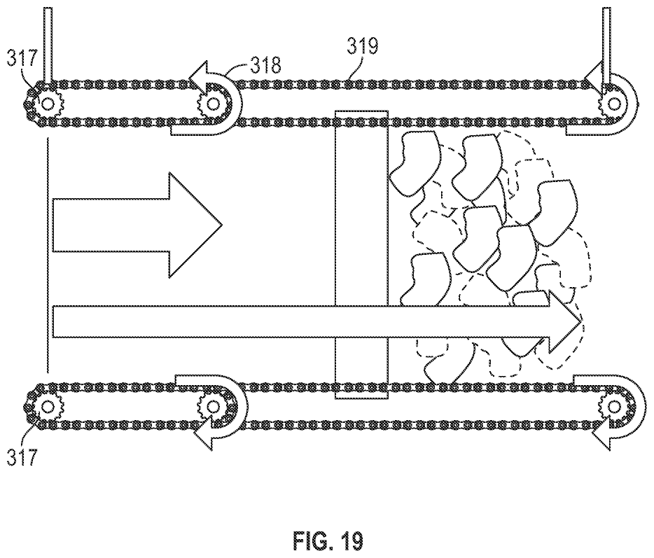

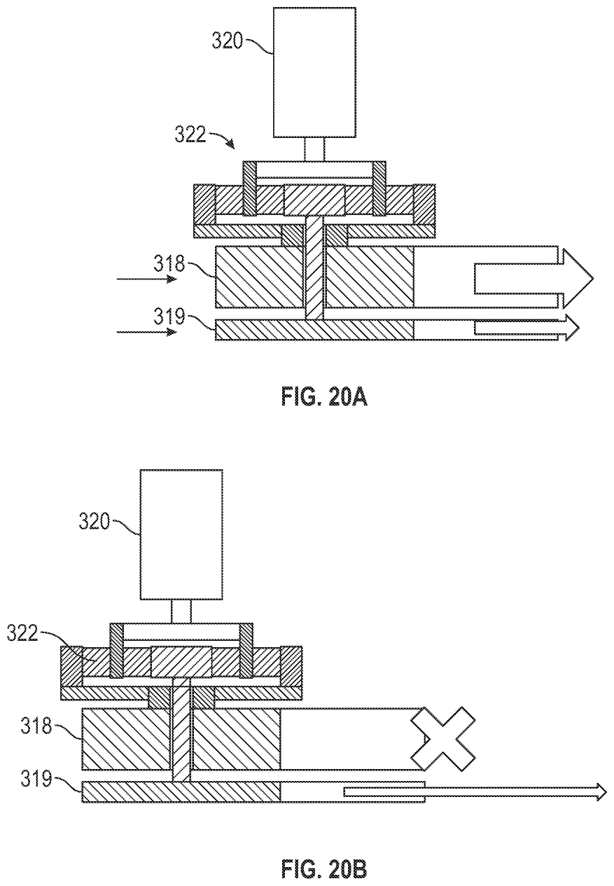

Turning to FIGS. 19 and 20, the telescopic chain drive described above can employ chains of differing lengths to control the distance that the sliding rails 312, 314 extend. In the exemplary embodiment, two chain lengths are used, a first chain length that results in the rails extending sufficiently for the subhopper 162 to move to a packing position (a packing conditions, i.e. a movement in which the subhopper moves at least partially into the storage volume 150 of the refuse compartment 130, pushing refuse into the storage volume), and a second length that results in the rails extending sufficiently for the subhopper to move to an eject position (an eject condition, i.e. a movement in which the subhopper moves into the storage volume of the refuse compartment sufficiently to eject refuse from the storage area when the tail gate 134 is open). The packing condition involves moving and crushing the refuse contained within the storage volume 150 of the refuse compartment 130, while the ejection condition may require less force as the refuse it being pushed out of the compartment. For this reason, a high torque chain 318 may be employed for the packing condition and a lower torque chain may be employed for the eject condition. The length of chain that is engaged by the motor can be selected by any known technique in the art. In the exemplary embodiment, the selection is controlled through the use of a planetary differential. During a packing condition, both chains will be engaged by the motor through the differential. But during the eject condition, by adjusting the speed of the motor, the differential will direct the torque to the low torque eject chain, and the high torque packing chain will bottom out and fail to fully extend.

Turning back to FIG. 18 particularly, the telescoping chain system can be housed within a cover to protect it from refuse and leached liquids. A stainless steel or spring steel (or other suitable material) strip can but used to cover the chains prevent refuse from being caught in the chains as they move. A spring-loaded scraper 324 may be placed near the cover strip 322 to remove any refuse that becomes attached to the cover strip.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or movable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X; Y; Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the refuse vehicle 110 and the subhopper 162, and the systems and components thereof, as shown in the various exemplary embodiments is illustrative only. Additionally, any element disclosed in one embodiment may be incorporated or utilized with any other embodiment disclosed herein.

1. A refuse vehicle comprising:
a chassis;
a cab coupled to the chassis;
a body coupled to the chassis and defining a hopper; and
a subhopper disposed least partially within the hopper, wherein the subhopper comprises a main body having a sloped upper surface configured to direct refuse deposited into the hopper toward an end of the hopper.

2. The refuse vehicle of claim 1 wherein the subhopper further comprises a packing assembly comprising a packer member coupled to an actuator, wherein the packer member is movable relative to the main body between a first position and a second position.

3. The refuse vehicle of claim 2, wherein the packer member is movable between the first position and the second position by rotation of the packer member.

4. The refuse vehicle of claim 1, further comprising an electric actuation system coupled to the subhopper, the electric actuation system configured to reposition the subhopper relative to the body within at least a portion of the hopper between a receiving position and an eject position.

5. The refuse vehicle of claim 1, wherein the subhopper includes at least one packing member movable with respect to the subhopper.

6. The refuse vehicle of claim 5, wherein the packing member is movable from a first ready position to a second packing position, and the subhopper and packing member are together movable to a third eject position.

7. The refuse vehicle of claim 1, wherein the subhopper further comprises a packing assembly comprising a plurality of packer members, the plurality of packer members independently actuatable relative to the main body from a first ready position to a second packing position.

8. The refuse vehicle of claim 7, wherein the two or more packer members are positioned in a vertical arrangement such that a first packer member is positioned below a second packer member.

9. The refuse vehicle of claim 7, wherein the two or more packer members are positioned in a horizontal arrangement such that a first packer member is positioned alongside a second packer member.

10. A subhopper for use in a refuse vehicle, the subhopper comprising:
a main body defining an interior cavity of the subhopper;
a packer member disposed within the interior cavity and movable relative to the main body between a receiving position and a packing position; and
an actuator coupled to the packer member and the main body and configured to selectively reposition (i) the packer member with respect to the main body, and (ii) both the main body and the packer member at the same time.

11. The subhopper of claim 10 further comprising a subhopper actuator coupled to the subhopper, wherein the subhopper is movable within a hopper between a first ready position and an eject position.

12. The subhopper of claim 10, wherein the main body includes a sloped upper surface configured to direct refuse deposited into the subhopper toward an end of the interior cavity of the subhopper.

13. The subhopper of claim 10 further comprising a second packer member positioned alongside the packer member in a horizontal relation, the second packer member actuatable between a first ready position and a second packing position.

14. The subhopper of claim 10 further comprising a second packer member positioned above the packer member in a vertical relation.

15. The subhopper of claim 10 wherein the packer member is movable between a ready first position and a second packing position by rotation of the packer member.

16. A subhopper assembly comprising:
a subhopper configured to be positioned within a hopper volume of a refuse container; and
a packer member positioned at least partially above the subhopper, wherein the packing member has a sloped upper surface and is moveable from a first ready position to a second packing position independent of the subhopper.

17. The subhopper assembly of claim 16 further comprising a subhopper actuator coupled to the subhopper, wherein the subhopper is configured to be movable within a hopper between a first ready position and an eject position.

18. The subhopper assembly of claim 16 further comprising a second packer member actuatable between a first ready position and a second packing position.

19. The subhopper assembly of claim 18 wherein the second packer member is positioned between the packer member and the subhopper in a vertical relation.

20. The subhopper assembly of claim 16 wherein the packer member is movable between a ready first position and a second packing position by rotation of the packer member.
